(19) United States
(12) Patent Application Publication
(10) Pub. No.: US 2023/0166689 A1
(43) Pub. Date: Jun. 1, 2023

(54) VEHICLE-MOUNTED APPARATUS, LOST PROPERTY NOTIFICATION METHOD, AND STORAGE MEDIUM

(71) Applicant: Panasonic Intellectual Property Management Co., Ltd., Osaka (JP)

(72) Inventors: Atsuto FUJIMOTO, Kanagawa (JP); Toshikazu HATTORI, Kanagawa (JP)

(73) Assignee: Panasonic Intellectual Property Management Co., Ltd., Osaka (JP)

(21) Appl. No.: 17/992,676

(22) Filed: Nov. 22, 2022

(30) Foreign Application Priority Data
Nov. 29, 2021 (JP) 2021-193196

(51) Int. Cl. B60R 25/30

(52) U.S. Cl. CPC B60R 25/30

(57) ABSTRACT

A vehicle-mounted apparatus communicates wirelessly with a terminal (user terminal) of a passenger of a vehicle and causes an electric field intensity maintaining unit to store an electric field intensity in wireless communication with the user terminal. The vehicle-mounted apparatus determines whether the user terminal is located in the vehicle based on a value related to a first electric field intensity acquired when a power supply of the vehicle is in a predetermined status and stored in the electric field intensity maintaining unit and based on a value related to a second electric field intensity acquired when the passenger leaves the vehicle and stored in the storage unit. The vehicle-mounted apparatus gives the passenger a predetermined notification when it is determined that the user terminal is located in the vehicle.

### BACKGROUND

### 1. Field

The present disclosure relates to data processing technology and, more particularly, to a vehicle-mounted apparatus, a lost property notification method, and a storage medium.

### 2. Description of the Related Art

A vehicular lost property prevention apparatus configured to capture an image of an vehicle interior with a camera, compare an image captured with the camera with a reference image, detect whether anything is left behind in the vehicle, and, when anything left behind is detected, notify the passenger or the driver of a lost property (see, for example, patent literature 1).

[Patent literature 1] JP2006-338535

Object detection using a camera has a problem in that it is difficult to detect an object in the shadows. Further, image processing imposes a heavy processing load on the CPU and consumes much memory.

### SUMMARY

The present disclosure addresses the above-described issue, and a purpose thereof is to provide a technology of realizing a vehicle-mounted apparatus that is suitable from the perspective of detecting a thing left in a vehicle with precision or the perspective of ease of implementation of lost property detection.

The vehicle-mounted apparatus according to an embodiment of the present disclosure includes a communication unit that communicates wirelessly with a terminal of a passenger of a vehicle and causes a storage unit to store an electric field intensity in wireless communication with the terminal; a determination unit that determines whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and a notification unit that gives the passenger a predetermined notification when it is determined that the terminal is located in the vehicle.

Another embodiment of the present invention relates to a lost property detection method. The method includes: communicating wirelessly with a terminal of a passenger of a vehicle and causing a storage unit to store an electric field intensity in wireless communication with the terminal; determining whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and giving the passenger a predetermined notification when it is determined that the terminal is located in the vehicle.

Optional combinations of the aforementioned constituting elements, and implementations of the present disclosure in the form of systems, computer programs, recording mediums recording computer programs, etc. may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a configuration of a vehicle according to the embodiment;

FIG. 2 is a flowchart showing the operation of the vehicle-mounted apparatus;

FIG. 3 shows a graph of normal distribution of intra-vehicular electric field intensity immediately before ACC OFF;

FIG. 4 shows a graph of intra-vehicular electric field intensity immediately before ACC OFF as converted into standard normal distribution;

FIG. 5 shows a smart key as the alert destination terminal;

FIG. 6 shows a distribution of intra-vehicular electric field intensity immediately before ACC OFF and an extra-vehicular electric field intensity; and

FIG. 7 shows a distribution of intra-vehicular electric field intensity immediately before ACC OFF and an extra-vehicular electric field intensity.

### DETAILED DESCRIPTION

The invention will now be described by reference to the preferred embodiments. This does not intend to limit the scope of the present invention, but to exemplify the invention.

The device or the entity that executes the method according to the disclosure is provided with a computer. By causing the computer to run a program, the function of the device or the entity that executes the method according to the disclosure is realized. The computer is comprised of a processor that operates in accordance with the program as a main hardware feature. The disclosure is non-limiting as to the type of the processor so long as the function is realized by running the program. The processor is comprised of one or a plurality of electronic circuits including a semiconductor integrated circuit (IC) or a large-scale integration (LSI). The terms IC and LSI may change depending on the integration degree, and the processor may be comprised of a system LSI, a very large scale integration (VLSI), or an ultra large scale integration (USLI). A field programmable gate array (FPGA), which is programmed after an LSI is manufactured, or a reconfigurable logic device, in which connections inside the LSI can be reconfigured or circuit compartments inside the LSI can be set up, can be used for the same purpose. The plurality of electronic circuits may be integrated in one chip or provided in a plurality of chips. The plurality of chips may be aggregated in one device or provided in a plurality of apparatuses. The program may be recorded in a non-transitory recording medium such as a computer-readable read only memory (ROM), optical disk, and hard disk drive or recorded in a non-transitory storage medium such as a computer-readable random access memory (RAM). The program may be stored in a recording medium in advance or supplied to a recording medium or a storage medium via a wide area communication network including the Internet.

A summary of the embodiment will be described.

Many of related-art technologies for detecting a thing left behind in a vehicle have been configured to detect an object in a vehicle by using an image captured with a camera (hereinafter, also referred to as “camera image”). Lost property detection in a vehicle using a camera image has the following problems.

(1) In the case of a camera image, it is difficult to detect an object in the shadows.

(2) It is troublesome for a user to provide a plurality of cameras in a vehicle cabin.

(3) Image processing imposes a heavy processing load on the CPU of the vehicle-mounted apparatus.

(4) Images and videos have large data volumes and consume much memory of the vehicle-mounted apparatus.

The vehicle-mounted apparatus of the embodiment refers to the electric field intensity in wireless communication with a terminal of a passenger (e.g., a smartphone) and determines whether the terminal is located in the vehicle or outside the vehicle. This configuration can make it easy to detect the terminal of the passenger even if it is in the shadows and can reduce the CPU processing load of the vehicle-mounted apparatus and the amount of memory consumption. Another advantage is that the terminal of the passenger need only be provided with an ordinary wireless communication function and it is not necessary to introduce a special application in the terminal of the passenger. In the embodiment, near field communication by way of Bluetooth Low Energy (hereinafter, also referred to as “BLE”) (“Bluetooth” and “Bluetooth Low Energy” are registered trademarks) is performed between the vehicle-mounted apparatus and the terminal of the passenger.

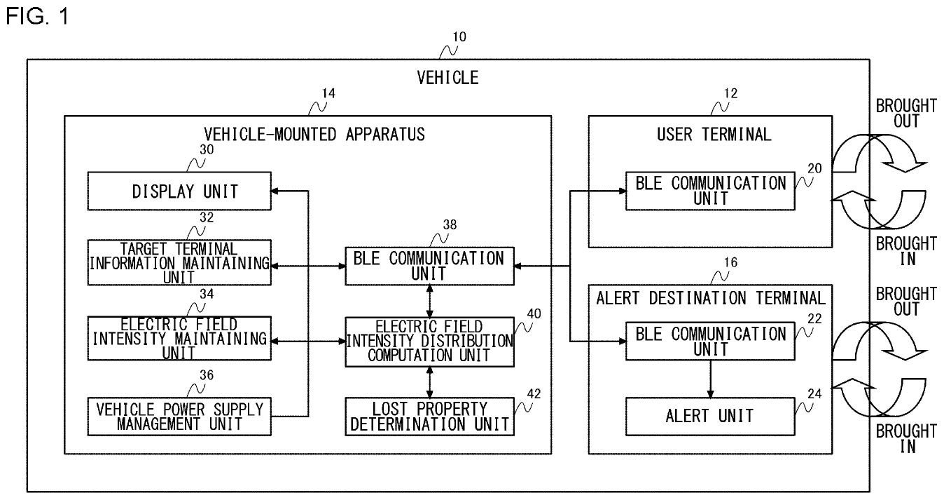

The embodiment will be described in detail. FIG. 1 shows a configuration of a vehicle 10 according to the embodiment. The vehicle 10 includes a user terminal 12, a vehicle-mounted apparatus 14, and an alert destination terminal 16. The user terminal 12 is a terminal used by a passenger (driver, etc.) of the vehicle 10. The passenger of the vehicle 10 brings in the user terminal 12 from outside the vehicle 10. After making a travel in the vehicle 10, the passenger brings out the user terminal 12 from inside the vehicle 10. The user terminal 12 may be a smartphone, a tablet terminal, or a wearable device. In the embodiment, the user terminal 12 is subject to lost property detection by the vehicle-mounted apparatus 14.

The vehicle-mounted apparatus 14 is an information processing apparatus for detecting a thing left behind in the vehicle 10. In the embodiment, the vehicle-mounted apparatus 14 detects a thing left behind in the vehicle 10 and notifies a passenger accordingly via the alert destination terminal 16. The vehicle-mounted apparatus 14 may be a car navigation apparatus or a vehicle-mounted infotainment apparatus.

The alert destination terminal 16 is a terminal notified of a thing detected by the vehicle-mounted apparatus 14 as being left behind in the vehicle 10. In the embodiment, the alert destination terminal 16 is a terminal notified that the user terminal 12 is left behind in the vehicle 10. The alert destination terminal 16 may be, for example, a smart key capable of locking or unlocking the door of the vehicle 10 without touching the vehicle 10.

FIG. 1 includes block diagrams showing functional blocks of the user terminal 12, the vehicle-mounted apparatus 14, and the alert destination terminal 16. The blocks depicted in the block diagram of this disclosure are implemented in hardware such as devices and mechanical apparatus exemplified by a CPU and a memory of a computer, and in software such as a computer program. FIG. 1 depicts functional blocks implemented by the cooperation of these elements. Therefore, it will be understood by those skilled in the art that the functional blocks may be implemented in a variety of manners by a combination of hardware and software.

The user terminal 12 includes a BLE communication unit 20. The BLE communication unit 20 communicates with the vehicle-mounted apparatus 14 by way of BLE.

The alert destination terminal 16 includes a BLE communication unit 22 and an alert unit 24. The BLE communication unit 22 communicates with the vehicle-mounted apparatus 14 by way of BLE. When the alert unit 24 receives a signal transmitted from the vehicle-mounted apparatus 14 and indicating that a thing is left behind in the vehicle 10 (hereinafter, “lost property notification signal”), the alert unit 24 performs a process for notifying the passenger that the thing is left behind in the vehicle 10. For example, the alert unit 24 may include an LED lamp and cause, when the lost property notification signal is received, the LED lamp to emit light in a predetermined manner indicating that the thing is left behind in the vehicle 10.

The vehicle-mounted apparatus 14 includes a display unit 30, a target terminal information maintaining unit 32, an electric field intensity maintaining unit 34, a vehicle power supply management unit 36, a BLE communication unit 38, an electric field intensity distribution computation unit 40, and a lost property determination unit 42.

The display unit 30 displays various information and acknowledges a user operation by a passenger. The display unit 30 may include a touch screen.

The target terminal information maintaining unit 32 stores information related to a terminal subject to lost property detection (in the embodiment, the user terminal 12). In the embodiment, the target terminal information maintaining unit 32 stores the Bluetooth device (BD) address of the user terminal 12 as the information related to the user terminal 12. The BD address is data used to identify a Bluetooth compatible device.

The electric field intensity maintaining unit 34 stores the value of electric field intensity in BLE communication with the user terminal 12, in association with the BD address of the user terminal 12. The number of values of electric field intensity stored in the electric field intensity maintaining unit 34 may be limited to a predetermined number. The predetermined number may be a number for which an appropriate statistic related to the electric field intensity can be calculated. For example, the predetermined number may be about 100.

The vehicle power supply management unit 36 manages the status of the power supply of the vehicle 10. For example, the vehicle power supply management unit 36 manages ON/OFF of the ignition power supply (IG) and ON/OFF of the accessory (ACC) power supply.

The BLE communication unit 38 performs BLE communication with the user terminal 12 and the alert destination terminal 16. The standard of BLE requires that the BLE communication unit 38 receives a signal transmitted from the user terminal 12 periodically (e.g., at every 10 milliseconds) and indicating that BLE communication is continuing. The signal includes the BD address of the user terminal 12. The BLE communication unit 38 derives the electric field intensity in BLE communication with the user terminal 12, based on the received signal described above. The BLE communication unit 38 causes the electric field intensity maintaining unit 34 to store the BD address of the user terminal 12 and the electric field intensity in association with each other.

The lost property determination unit 42 determines whether the user terminal 12 is located in the vehicle 10, i.e., whether the user terminal 12 is left behind in the vehicle 10, based on the value related to the first electric field intensity stored in the electric field intensity maintaining unit 34 when the status of the power supply of the vehicle 10 is a predetermined status (in the embodiment, the ACC power supply is OFF) and the value related to the second electric field intensity stored in the electric field intensity maintaining unit 34 when the passenger left the vehicle 10. The first electric field intensity is an electric field intensity in BLE communication with the user terminal 12 immediately before the ACC power supply of the vehicle 10 is switched from ON to OFF and will be referred to as “intra-vehicular electric field intensity” hereinafter. The second electric field intensity is an electric field intensity in BLE communication with the user terminal 12 immediately after the passenger left the vehicle and will be referred to as “extra-vehicular electric field intensity” hereinafter.

When the lost property determination unit 42 determines that the user terminal 12 is located in the vehicle 10, the BLE communication unit 38 as a notification unit gives the passenger who left the vehicle 10 a predetermined notification.

More specifically, the electric field intensity distribution computation unit 40 calculates the statistic related to the intra-vehicular electric field intensity, based on a plurality of items of data for intra-vehicular electric field intensity acquired when the status of the power supply of the vehicle 10 is a predetermined status in the embodiment, the ACC power supply OFF) and stored in the electric field intensity maintaining unit 34. In other words, when the status of the power supply of the vehicle 10 is switched from ACC power supply ON to ACC power supply OFF, the electric field intensity distribution computation unit 40 calculates the statistic related to the intra-vehicular electric field intensity of the user terminal 12 up to that time. The lost property determination unit 42 determines whether the user terminal 12 is located in the vehicle 10 based on the statistic related to the intra-vehicular electric field intensity and the extra-vehicular electric field intensity.

Still more specifically, the electric field intensity distribution computation unit 40 calculates a summary statistic related to the intra-vehicular electric field intensity and, in the embodiment, calculates an average and a standard deviation of the intra-vehicular electric field intensity. The lost property determination unit 42 standardizes the value of extra-vehicular electric field intensity based on the average and the standard deviation of intra-vehicular electric field intensity. When the standardized value is equal to or smaller than a predetermined threshold value, the lost property determination unit 42 determines that the user terminal 12 is located in the vehicle.

The target terminal information maintaining unit 32 and the electric field intensity maintaining unit 34 may be implemented by the storage of the vehicle-mounted apparatus 14. Further, a computer program implementing the functions of the vehicle power supply management unit 36, the BLE communication unit 38, the electric field intensity distribution computation unit 40, and the lost property determination unit 42 may be installed in the storage of the vehicle-mounted apparatus 14. The processor (CPU, etc.) of the vehicle-mounted apparatus 14 may exhibit the functions of the vehicle power supply management unit 36, the BLE communication unit 38, the electric field intensity distribution computation unit 40, and the lost property determination unit 42 by reading the computer program into the main memory and executing the computer program.

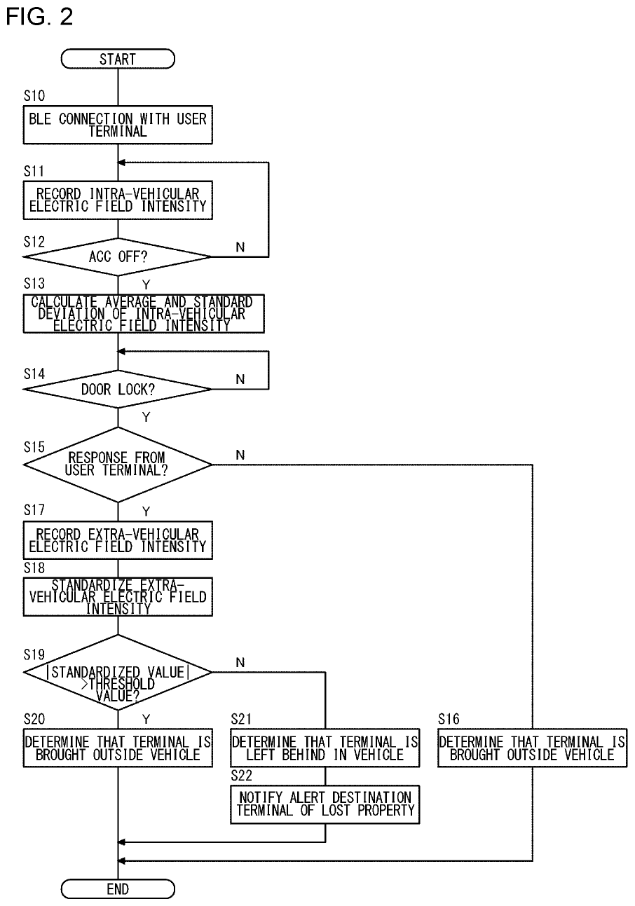

A description will be given of the operation of the vehicle-mounted apparatus 14, the user terminal 12, and the alert destination terminal 16 having the above-described configuration. FIG. 2 is a flowchart showing the operation of the vehicle-mounted apparatus 14. The BLE communication unit 38 of the vehicle-mounted apparatus 14 establishes BLE communication with the BLE communication unit 20 of the user terminal 12 (S10). Further, the BLE communication unit 38 of the vehicle-mounted apparatus 14 also establishes BLE communication with the BLE communication unit 22 of the alert destination terminal 16.

The display unit 30 of the vehicle-mounted apparatus 14 displays the fact that BLE communication with the user terminal 12 is established on the screen and also displays an inquiry as to whether the user terminal 12 is set as a target terminal subject to lost property detection on the screen (not shown). When the passenger enters a user operation in the display unit 30 to set the user terminal 12 as a target terminal subject to lost property detection, the target terminal information maintaining unit 32 of the vehicle-mounted apparatus 14 stores the identification information (in the embodiment, the BD address) on the user terminal 12 as the identification on the target terminal subject to lost property detection.

The BLE communication unit 20 of the user terminal 12 transmits a signal (a data packet of BLE communication), indicating that BLE communication is continuing, to the BLE communication unit 38 of the vehicle-mounted apparatus 14 periodically (e.g., at every 10 milliseconds). The BLE communication unit 20 communicates information indicating the electric field intensity to the BLE communication unit 38 of the vehicle-mounted apparatus 14, superimposing the information on the data packet. The BLE communication unit 38 of the vehicle-mounted apparatus 14 causes the electric field intensity maintaining unit 34 to store, as the value of intra-vehicular electric field intensity, the value of electric field intensity indicated by the data packet transmitted from the user terminal 12, in association with the BD address of the user terminal 12 (S11).

While the passenger does not enter a user operation (hereinafter, also referred to as “ACC OFF user operation”) to switch the ACC power supply of the vehicle 10 from ON to OFF (N in S12), and, typically, while the vehicle 10 is traveling, the process of S11 is repeated periodically. The electric field intensity maintaining unit 34 stores, at a maximum, a predetermined number (e.g., 100) of past and most recent values as the values of intra-vehicular electric field intensity of the user terminal 12.

When the passenger enters an ACC OFF user operation (Y in S12), the vehicle power supply management unit 36 of the vehicle-mounted apparatus 14 detects the user operation and notifies the BLE communication unit 38 of ACC OFF. The BLE communication unit 38 acquires information on a target terminal subject to lost property detection (in the embodiment, the BD address of the user terminal 12) from the target terminal information maintaining unit 32 and transmits an electric field intensity distribution creation request, designating the BD address of the user terminal 12, to the electric field intensity distribution computation unit 40. The electric field intensity distribution computation unit 40 acquires a plurality of intra-vehicular electric field intensities of the user terminal 12 immediately before ACC OFF stored in the electric field intensity maintaining unit 34. In the embodiment, 100 samples of intra-vehicular electric field intensity of the user terminal 12 stored in the electric field intensity maintaining unit 34 are acquired. The electric field intensity distribution computation unit 40 calculates the average p and the standard deviation σ of intra-vehicular electric field intensity of the user terminal 12 (S13).

The vehicle-mounted apparatus 14 (e.g., the vehicle power supply management unit 36 or the BLE communication unit 38) stands by until a door lock request is received (N in S14). The passenger leaves the vehicle 10 and locks the door of the vehicle 10 by using a smart key also used as the alert destination terminal 16. The smart key transmits the door lock request to the vehicle power supply management unit 36 of the vehicle-mounted apparatus 14. When the vehicle power supply management unit 36 receives the door lock request (Y in S14), the vehicle power supply management unit 36 notifies the BLE communication unit 38 accordingly. The BLE communication unit 38 acquires the information on the target terminal subject to lost property detection (in the embodiment, the BD address of the user terminal 12) from the target terminal information maintaining unit 32.

When the BLE communication unit 38 of the vehicle-mounted apparatus 14 does not receive a signal (a data packet of BLE communication) transmitted from the user terminal 12 and indicating that BLE connection is continuing within a predetermined period of time (N in S15), the BLE communication unit 38 notifies the lost property determination unit 42 that the data packet from the user terminal 12 is no longer received. The lost property determination unit 42 determines that the user terminal 12, which is the target terminal subject to lost property detection, is brought outside the vehicle 10 and terminates the process of the figure (S16).

When the BLE communication unit 38 of the vehicle-mounted apparatus 14 receives a data packet transmitted from the user terminal 12 within a predetermined period of time (Y in S15), the BLE communication unit 38 causes the electric field intensity maintaining unit 34 to store value of electric field intensity indicated by the data packet from the user terminal 12 as the value of extra-vehicular electric field intensity (S17). The BLE communication unit 38 transmits a lost property determination request designating the BD address of the user terminal 12 to the electric field intensity distribution computation unit 40, and the electric field intensity distribution computation unit 40 transmits the lost property determination request to the lost property determination unit 42. The lost property determination unit 42 requests a value (Z_outside) derived from standardizing the extra-vehicular electric field intensity (R_outside) of the user terminal 12 from the electric field intensity distribution computation unit 40.

The electric field intensity distribution computation unit 40 acquires the extra-vehicular electric field intensity (R_outside) of the user terminal 12 stored in the electric field intensity maintaining unit 34. The electric field intensity distribution computation unit 40 calculates Z_outside based on the average p and the standard deviation σ of intra-vehicular electric field intensity of the user terminal 12 derived in S13. More specifically, the electric field intensity distribution computation unit 40 calculates Z_outside according to expression 1 below (S18).

$$Z\_outside = \frac{R\_outside - μ}{σ} \qquad ( expression 1 )$$

The electric field intensity distribution computation unit 40 communicates Z_outside to the lost property determination unit 42. The lost property determination unit 42 compares a threshold value Z predefined to discriminate between inside and outside of the vehicle with the absolute value of Z_outside. A proper threshold value Z may be determined according to the knowledge or experiments of the developer. Further, different values of the threshold value Z may be set depending on the type and size of the vehicle 10.

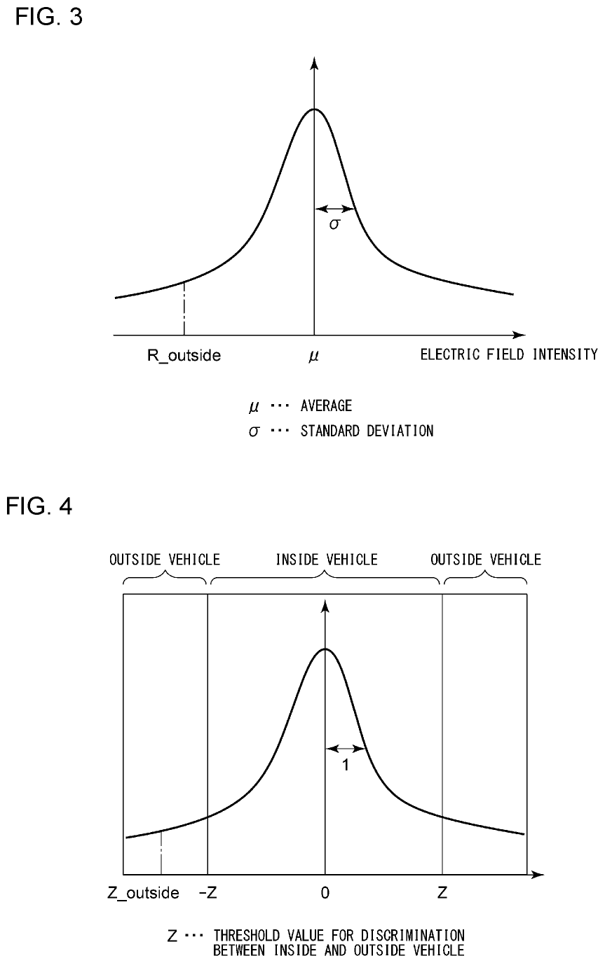

FIG. 3 shows a graph of normal distribution of intra-vehicular electric field intensity immediately before ACC OFF. FIG. 4 shows a graph of intra-vehicular electric field intensity immediately before ACC OFF as converted into standard normal distribution (average 0, standard deviation 1). It can be said that the threshold value Z defines a distance from the average. When the absolute value of Z_outside is beyond the threshold value Z as shown in FIG. 4 (Y in S19), the lost property determination unit 42 determines that the user terminal 12, which is a target terminal subject to lost property detection, has been brought outside the vehicle 10 and terminates the process of the figure (S20).

When the absolute value of Z_outside is equal to or smaller than the threshold value Z (N in S19), the lost property determination unit 42 determines that the user terminal 12, which is a target terminal subject to lost property detection, is left behind in the vehicle 10 (S21). The lost property determination unit 42 notifies the electric field intensity distribution computation unit 40 that a thing is left behind in the vehicle 10, and the electric field intensity distribution computation unit 40 notifies the BLE communication unit 38 that a thing is left behind in the vehicle 10.

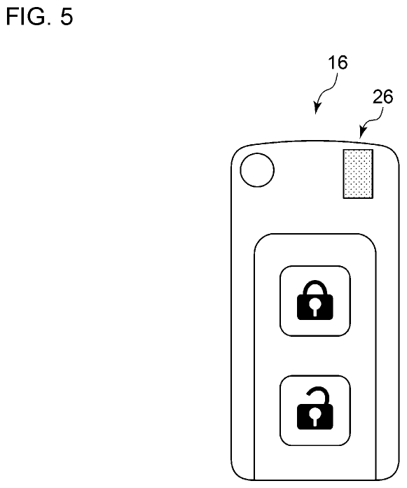

The BLE communication unit 38 transmits a signal indicating that a thing is left behind in the vehicle 10 (lost property notification signal) to the alert destination terminal 16 (S22). The BLE communication unit 22 of the alert destination terminal 16 receives the lost property notification signal, and the alert unit 24 of the alert destination terminal 16 performs a predetermined operation for notifying of a lost property. FIG. 5 shows a smart key as the alert destination terminal 16. When the lost property notification signal is received, the alert unit 24 of the alert destination terminal 16 causes the LED lamp 26 to emit light in a predetermined manner.

According to the vehicle-mounted apparatus 14 of the embodiment, it is possible to detect that the user terminal 12 is left behind in the vehicle 10 with precision, based on the variation in the electrical field intensity in BLE communication with the user terminal 12 and to secure ease of implementation of lost property detection. Further, precision and robustness of lost property detection can be improved by using a statistic of electric field intensity immediately before ACC OFF (i.e., immediately before the passenger leaves the vehicle) for lost property detection.

A description will now be given of an exemplary setting the threshold value Z for discrimination between inside and outside of the vehicle. A value based on the standard deviation in normal standard distribution of intra-vehicular electric field intensity immediately before ACC OFF may be used as the threshold value Z. For example, (1) the threshold value may be such that Z=1.0 (i.e., 1σ). In this case, the probability that the user terminal 12 is located in the vehicle 10 would be 68% provided that the absolute value of Z_outside is equal to or smaller than the threshold value Z. Alternatively, (2) the threshold value may be such that Z=2.0 (i.e., 2σ). In this case, the probability that the user terminal 12 is located in the vehicle 10 would be 95% provided that the absolute value of Z_outside is equal to or smaller than the threshold value Z.

A value dependent on the magnitude of intra-vehicular electric field intensity sampled for creation of normal distribution (i.e., calculation of the average and the standard deviation) may be set as the threshold value Z. More specifically, (3) a value based on the average of intra-vehicular electric field intensity immediately before ACC OFF may be set as the threshold value Z. In this case, the lost property determination unit 42 of the vehicle-mounted apparatus 14 may dynamically adjust the threshold value Z based on the average of the intra-vehicular electric field intensity immediately before ACC OFF.

It is assumed here that the BLE receiver (corresponding to the BLE communication unit 38 of the vehicle-mounted apparatus 14) for measuring the electric field intensity is provided toward the front of the vehicle 10 like an ordinary car navigation apparatus. When the user terminal 12 is located toward the back of the vehicle 10 or under the seat, the intra-vehicle electric field intensity detected by the BLE receiver may be low due to an impact from an obstacle. A lower intra-vehicular electric field intensity means a lower precision of determination as to whether the user terminal 12 is located inside or outside the vehicle 10. Thus, when the average value of intra-vehicular electric field intensity acquired immediately before ACC OFF of the vehicle 10 is low, a smaller threshold value Z makes it easier to prevent an erroneous determination.

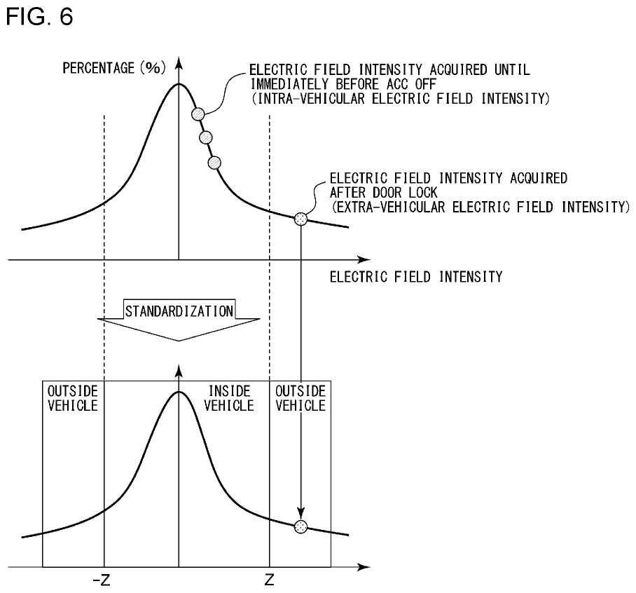

A description will be given of Case 1 where the average value of intra-vehicular electric field intensity acquired immediately before ACC OFF is relatively high. FIG. 6 shows a distribution of intra-vehicular electric field intensity immediately before ACC OFF and an extra-vehicular electric field intensity. The figure shows a graph of normal distribution of intra-vehicular electric field intensity immediately before ACC OFF and a graph of intra-vehicular electric field intensity immediately before ACC OFF as converted into standard normal distribution (average 0, standard deviation 1) related to Case 1.

When the average value of intra-vehicular electric field intensity acquired immediately before ACC OFF is higher than a predetermined threshold value (the threshold value may be determined according to the knowledge or experiments of the developer), the lost property determination unit 42 sets the threshold value Z to be a relatively large value. For example, the lost property determination unit 42 may set the threshold value such that Z=2.0 (i.e., 2σ). This is because the difference in electric field intensity inside and outside the vehicle is large and an erroneous determination is unlikely to occur even if the threshold value Z is set to be large.

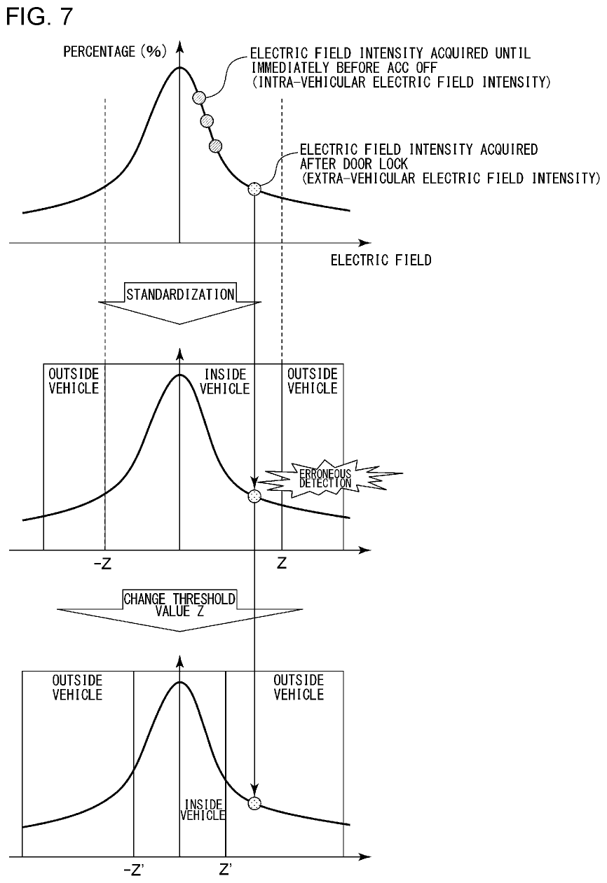

A description will be given of Case 2 where the average value of intra-vehicular electric field intensity acquired immediately before ACC OFF is relatively low. FIG. 7 shows a distribution of intra-vehicular electric field intensity immediately before ACC OFF and an extra-vehicular electric field intensity. The figure shows a graph of normal distribution of intra-vehicular electric field intensity immediately before ACC OFF and a graph of intra-vehicular electric field intensity immediately before ACC OFF as converted into standard normal distribution (average 0, standard deviation 1) related to Case 2.

When the average value of intra-vehicular electric field intensity acquired immediately before ACC OFF is relatively low, the difference in electric field intensity inside and outside the vehicle will be small. Therefore, the likelihood that the user terminal 12 is erroneously detected as being located in the vehicle 10 is high if the threshold value Z is large. Stated otherwise, the likelihood that the passenger is notified of lost property detection even if the passenger brought the user terminal 12 outside the vehicle 10 will be higher.

Thus, the lost property determination unit 42 configures the threshold value Z to be a relatively small value when the average value of intra-vehicular electric field intensity acquired immediately before ACC OFF is smaller than the above threshold value (the threshold value already described in Case 1). For example, the lost property determination unit 42 may set the threshold value such that Z=1.0 (i.e., 1σ). Thus, a smaller threshold value Z makes it easy to prevent an erroneous determination as to whether the terminal is inside or outside the vehicle. When the threshold value Z is too small, the user terminal 12 may be determined as being outside the vehicle 10 despite the fact that the user terminal 12 is left behind in the vehicle 10. It is therefore desired to set an appropriate threshold value Z (the lower limit value, the upper limit value, etc.) through experiments, etc. Further, the vehicle-mounted apparatus 14 may be configured to variably switch the threshold value Z by employing (1) above, where the threshold value Z=1.0 (i.e., 1σ), in normal times and employing (3) above when a feedback indicating numerous erroneous detections is input from the driver, etc.

Described above is an explanation based on an exemplary embodiment. The embodiment is intended to be illustrative only and it will be understood by those skilled in the art that various modifications to constituting elements and processes could be developed and that such modifications are also within the scope of the present disclosure.

A description will be given of a variation. In the embodiment, the LED lamp of the alert destination terminal 16 is caused to emit light to notify the passenger of a lost property in the vehicle 10. In one variation, the alert destination terminal 16 may notify the passenger of a lost property by vibrating in a predetermined manner or outputting predetermined sound in accordance with the lost property notification signal. Alternatively, the notification unit of the vehicle-mounted apparatus 14 may notify the passenger of a lost property by activating a horn of the vehicle 10 or turning on the light, hazard lamp, etc. of the vehicle 10 in a predetermined manner. Alternatively, the notification unit of the vehicle-mounted apparatus 14 may transmit a message indicating a lost property in the vehicle 10 to an external apparatus predesignated by the passenger.

Another variation will be described. A plurality of terminals (herein, referred to as a first user terminal and a second user terminal) may be designated as target terminals subject to lost property detection, although the variation is not mentioned in the embodiment. The vehicle-mounted apparatus 14 may store the intra-vehicular electric field intensity in BLE communication with the first user terminal in association with the identification information (e.g., the BD address) on the first user terminal and store the intra-vehicular electric field intensity in BLE communication with the second user terminal in association with the identification information on the second user terminal. The vehicle-mounted apparatus 14 may calculate the average value and the standard deviation of intra-vehicular electric field intensity of the first user terminal and calculate the average value and the standard deviation of intra-vehicular electric field intensity of the second user terminal, when the ACC power supply is turned OFF.

The vehicle-mounted apparatus 14 may subsequently determine whether the first user terminal is left behind in the vehicle 10 by acquiring the extra-vehicular electric field intensity of the first user terminal when a door lock request is received from the smart key and by standardizing the extra-vehicular electric field intensity and comparing it with the threshold value (Z). In addition to that, the vehicle-mounted apparatus 14 may determine whether the second user terminal is left behind in the vehicle 10 by acquiring the extra-vehicular electric field intensity of the second user terminal and by standardizing the extra-vehicular electric field intensity and comparing it with the same threshold value (Z). When the vehicle-mounted apparatus 14 determines that at least one of the first user terminal and the second user terminal is left behind in the vehicle 10, the vehicle-mounted apparatus 14 may notify the alert destination terminal 16 that a terminal is left behind in the vehicle 10.

Yet another variation will be described. In the above embodiment, the terminal subject to lost property detection (in the embodiment, the user terminal 12) and the vehicle-mounted apparatus 14 communicate by using BLE. The technical idea described in the embodiment can also be used in cases where the target terminal subject to lost property detection and the vehicle-mounted apparatus 14 communicate wirelessly in a scheme other than BLE. For example, the target terminal subject to lost property detection and the vehicle-mounted apparatus 14 may communicate wirelessly by using one of Bluetooth Basic Rate/Enhanced Data Rate, wireless LAN, Wi-Fi (registered trademark), and wireless USB.

Any combination of the embodiment and the variation described above will also be useful as an embodiment of the present invention. A new embodiment created by a combination will provide the combined advantages of the embodiment and the variation as combined. It will be understood to a skilled person that the functions that the constituting elements recited in the claims should achieve are implemented either alone or in combination by the constituting elements shown in the embodiments and the variations. Terms like “first”, “second”, etc. used in the specification and claims do not indicate an order or importance by any means unless specified otherwise and are used to distinguish a certain feature from the others.

The technology disclosed in the embodiment and the variation may be defined by the modes described in the following items.

### [Item 1]

A vehicle-mounted apparatus including: a communication unit that communicates wirelessly with a terminal of a passenger of a vehicle and causes a storage unit to store an electric field intensity in wireless communication with the terminal; a determination unit that determines whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and a notification unit that gives the passenger a predetermined notification when it is determined that the terminal is located in the vehicle.

According to this vehicle-mounted apparatus, it is possible to detect the presence of a terminal left behind by a passenger in a vehicle with precision and notify the passenger accordingly.

In further accordance with the vehicle-mounted apparatus, a determination is made as to whether anything is left behind based on the electric field intensity in wireless communication with the terminal so that the processing load on the vehicle-mounted apparatus and the amount of resources required for the process can be reduced.

### [Item 2]

The vehicle-mounted apparatus according to item 1, further including: a computation unit that calculates a statistic related to the first electric field intensity based on a plurality of items of data for the first electric field intensity acquired when a power supply of the vehicle is in a predetermined status and stored in the storage unit, wherein the determination unit determines whether the terminal is located in the vehicle based on the statistic related to the first electric field intensity and the value related to the second electric field intensity.

According to this vehicle-mounted apparatus, it is possible to detect the presence of the terminal left behind in the vehicle even more precisely.

### [Item 3]

The vehicle-mounted apparatus according to item 2, wherein the computation unit calculates an average and a standard deviation of the first electric field intensity as the statistic related to the first electric field intensity, and the determination unit standardizes the value related to the second electric field intensity based on the average and the standard deviation of the first electric field intensity and, when a standardized value is equal to or smaller than a predetermined threshold value, determines that the terminal is located in the vehicle.

According to this vehicle-mounted apparatus, it is possible to detect the presence of the terminal left behind in the vehicle even more precisely.

### [Item 4]

The vehicle-mounted apparatus according to item 3, wherein the threshold value is a value based on a standard deviation in standard normal distribution of the first electric field intensity.

According to this vehicle-mounted apparatus, it is possible to set a threshold value for determining whether the terminal of the passenger is located in the vehicle more properly.

### [Item 5]

The vehicle-mounted apparatus according to item 3 or 4, wherein the threshold value is a value based on the average of the first electric field intensity.

According to this vehicle-mounted apparatus, it is possible to set a threshold value for determining whether the terminal of the passenger is located in the vehicle more properly.

### [Item 6]

The vehicle-mounted apparatus according to any one of items 1 through 5, wherein the predetermined status of the power supply of the vehicle is a status in which an accessory power supply of the vehicle is turned off.

According to this vehicle-mounted apparatus, precision and robustness of lost property detection can be improved by using a value related to the first electric field intensity immediately before the accessory power supply is turned off for lost property detection.

### [Item 7]

A lost property detection method including:

communicating wirelessly with a terminal of a passenger of a vehicle and causing a storage unit to store an electric field intensity in wireless communication with the terminal;

determining whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and

giving the passenger a predetermined notification when it is determined that the terminal is located in the vehicle.

According to this method, it is possible to detect the presence of a terminal left behind by a passenger in a vehicle with precision and notify the passenger accordingly.

In further accordance with the method, a determination is made as to whether anything is left behind based on the electric field intensity in wireless communication with the terminal so that the processing load on the vehicle-mounted apparatus and the amount of resources required for the process can be reduced.

### [Item 8]

A non-transitory computer-readable storage medium storing a computer program implemented in a vehicle-mounted apparatus, the computer program including modules that include:

a module that communicates wirelessly with a terminal of a passenger of a vehicle and causes a storage unit to store an electric field intensity in wireless communication with the terminal;

a module that determines whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and

a module that gives the passenger a predetermined notification when it is determined that the terminal is located in the vehicle.

According to the vehicle-mounted apparatus in which the computer program is implemented, it is possible to detect the presence of a terminal left behind by a passenger in a vehicle with precision and notify the passenger accordingly. In further accordance with the vehicle-mounted apparatus, a determination is made as to whether anything is left behind based on the electric field intensity in wireless communication with the terminal so that the processing load on the vehicle-mounted apparatus and the amount of resources required for the process can be reduced.

### CROSS-REFERENCE TO RELATED APPLICATION

This application is based upon and claims the benefit of priority from the prior Japanese Patent Application No. 2021-193196, filed on Nov. 29, 2021, the entire contents of which are incorporated herein by reference.

What is claimed is:

1. A vehicle-mounted apparatus comprising:
a communication unit that communicates wirelessly with a terminal of a passenger of a vehicle and causes a storage unit to store an electric field intensity in wireless communication with the terminal;
a determination unit that determines whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and
a notification unit that gives the passenger a predetermined notification when it is determined that the terminal is located in the vehicle.

2. The vehicle-mounted apparatus according to claim 1, further comprising:
a computation unit that calculates a statistic related to the first electric field intensity based on a plurality of items of data for the first electric field intensity acquired when a power supply of the vehicle is in a predetermined status and stored in the storage unit, wherein
the determination unit determines whether the terminal is located in the vehicle based on the statistic related to the first electric field intensity and the value related to the second electric field intensity.

3. The vehicle-mounted apparatus according to claim 2, wherein
the computation unit calculates an average and a standard deviation of the first electric field intensity as the statistic related to the first electric field intensity, and
the determination unit standardizes the value related to the second electric field intensity based on the average and the standard deviation of the first electric field intensity and, when a standardized value is equal to or smaller than a predetermined threshold value, determines that the terminal is located in the vehicle.

4. The vehicle-mounted apparatus according to claim 3, wherein
the threshold value is a value based on a standard deviation in standard normal distribution of the first electric field intensity.

5. The vehicle-mounted apparatus according to claim 3, wherein
the threshold value is a value based on the average of the first electric field intensity.

6. The vehicle-mounted apparatus according to claim 1, wherein
the predetermined status of the power supply of the vehicle is a status in which an accessory power supply of the vehicle is turned off.

7. A lost property detection method comprising:
communicating wirelessly with a terminal of a passenger of a vehicle and causing a storage unit to store an electric field intensity in wireless communication with the terminal;
determining whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and
giving the passenger a predetermined notification when it is determined that the terminal is located in the vehicle.

8. A non-transitory computer-readable storage medium storing a computer program implemented in a vehicle-mounted apparatus, the computer program comprising modules that include:
a module that communicates wirelessly with a terminal of a passenger of a vehicle and causes a storage unit to store an electric field intensity in wireless communication with the terminal;
a module that determines whether the terminal is located in the vehicle based on a value related to a first electric field intensity acquired when a power supply of the vehicle is in a predetermined status and stored in the storage unit and based on a value related to a second electric field intensity acquired when the passenger leaves the vehicle and stored in the storage unit; and
a module that gives the passenger a predetermined notification when it is determined that the terminal is located in the vehicle.
